(19) United States
(12) Patent Application Publication
(10) Pub. No.: US 2014/0344599 A1
(43) Pub. Date: Nov. 20, 2014

(54) Method and System for Power Management

(71) Applicant: Advanced Micro Devices, Inc., Sunnyvale, CA (US)

(72) Inventors: Alexander J. Branover, Chestnut Hill, MA (US); Jonathan D. Hauke, Lexington, MA (US)

(73) Assignee: Advanced Micro Devices, Inc., Sunnyvale, CA (US)

(21) Appl. No.: 13/894,816

(22) Filed: May 15, 2013

(51) Int. Cl. G06F 1/32

(52) U.S. Cl. CPC G06F 1/3234
USPC 713/323

(57) ABSTRACT

Embodiments described herein include a method for power management. In an embodiment, the method includes responsive to a determination that an idle time has exceeded a threshold, transitioning a device to an intermediate power state in which a predetermined processing module of the device is powered down, the idle time being a time since a last wakeup event, and determining whether to transition the device from the intermediate power state to a substantially powered down state.

### BACKGROUND

1. Field

Embodiments described herein generally relate to managing power consumption of a device.

2. Background

In mobile computing systems, which often rely on batteries for power, power use is a significant concern. To extend battery life, the power supplied to the mobile computing system when it is not executing any tasks can be reduced. For example, the computing system's operating system can control a transition to a sleep state. In this sleep state, substantially all components of the computing system are powered down.

Although transitioning to this sleep state reduces the power consumed by the device, it may also have negative impacts on the user's experience. For example, the “wakeup time,” e.g., the time to transition from the sleep state to the active state, may be of the order of one second. Also, in the sleep state, the device may not be able to maintain an uninterrupted association with a network and the time needed to reestablish a network connection after transitioning to the active state may be on the order of one minute. Furthermore, in some implementations, the OS's decision to transition to the sleep state may only consider the activity or inactivity of a specific portion of the device.

### SUMMARY OF THE EMBODIMENTS

Embodiments described herein generally relate to a granular method for power management that includes the use of one or more intermediate states. In some embodiments, the method includes being responsive to a determination that an idle time has exceeded a threshold, by transitioning a device to an intermediate power state in which a predetermined processing module of the device is powered down, the idle time being a time since a last wakeup event, and determining whether to transition the device from the intermediate power state to a substantially powered down state.

In some embodiments, a non-transitory computer-readable device having instructions stored thereon that, when executed by at least one computing device, causes at least one computing device to perform operations comprising: responsive to a determination that an idle time has exceeded a threshold, transitioning a device to an intermediate power state in which a predetermined processing module of the device is powered down, the idle time being a time since a last wakeup event and determining whether to transition the device from the intermediate power state to a substantially powered down state.

These and other advantages and features will become readily apparent in view of the following detailed description. Note that the Summary and Abstract sections may set forth one or more, but not all example embodiments of the disclosed subject matter as contemplated by the inventor(s).

### BRIEF DESCRIPTION OF THE DRAWINGS/FIGURES

The accompanying drawings, which are incorporated herein and form a part of the specification, illustrate the disclosed subject matter and, together with the description, further serve to explain the principles of the contemplated embodiments and to enable a person skilled in the pertinent art to make and use the contemplated embodiments.

FIG. 1 is a block diagram illustration of a device, according to some embodiments.

FIG. 2 is a state diagram, according to some embodiments.

FIG. 3 is a flowchart of a method of power management, according to some embodiments.

FIG. 4 illustrates an example computer system in which embodiments, or portions thereof, may be implemented as computer-readable code.

The disclosed subject matter will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

Power consumption is a significant concern for many different types of computing systems, especially mobile computing systems. To reduce the amount of power that is wasted, the power supplied to a device when it is not executing any tasks can be reduced. For example, in one implementation, an operating system (OS) running on the device controls the device to by transitioning it to a sleep state in which substantially all components of the device are powered down.

Although transitioning to this OS-controlled sleep state reduces the power consumed by the device, it may also have negative impacts on the user's experience. For example, the “wakeup time,” e.g., the time to transition from the sleep state to the active state, may be on the order of one second. Also, in the OS-controlled sleep state, the device may not be able to maintain an uninterrupted association with a network and the time needed to reestablish a network connection after transitioning to the active state may be on the order of one minute. Furthermore, in some implementations, the OS's decision to transition to the sleep state may only consider the activity or inactivity of a specific portion of the device.

In another implementation, a “connected-standby” state can be used if the device is inactive. The connected-standby state is similar to the OS-controlled sleep state mentioned above in that substantially the entire device is powered down. In the connected-standby state, however, the transition between the active state and the connected-standby state is not managed by the operating system. In fact, in some implementations, transitioning to and from the connected-standby state can be invisible to the operating system. Instead, the transition can be managed by a controller included in the device.

Although the connected-standby state has a wakeup time that is shorter than the OS-controlled sleep state (e.g., on the order of 100 ms), this wakeup latency may also have negative impacts on the user's experience. In particular, when the period of inactivity is shorter than the wakeup time, the device may experience rapid transitions between the active state and the connected-standby state. These rapid transitions can negatively impact the user's experience.

In embodiments described herein, a granular power management method can be provided in which a device is transitioned to one or more intermediate power states. For example, a device can include a power management controller that controls the transition of the device between an active state, one or more intermediate power states, and a substantially powered down state (e.g., the connected-standby state). The decisions to transition between states can be made based on two measures: an idle time and a time to the next wakeup event. An idle time can be a backward looking measure specifying the time since the last activity on the device. The time to the next wakeup event, on the other hand, can be a forward looking prediction of when the next wakeup event is expected. For example, the device can include one or more timers that are configured to fire at certain intervals. By checking the state of these timers, the power management controller can estimate when the interrupt will be generated. In alternate embodiments, the time to the next wakeup event can be predicted using a predictor such as an interrupt predictor.

In an embodiment, the power management controller can control the device to transition to an intermediate state and to transition between different intermediate states based on the idle time exceeding one or more thresholds. For example, the power management controller can control the device to transition from an idle state, in which the device is not Performing any active tasks, to a first intermediate state when the idle time exceeds a first threshold. Thereafter, the power management controller can control the device to transition to other intermediate states based on the idle time exceeding thresholds. On the other hand, if a wakeup event is detected (e.g., an interrupt), the power management controller can control the device to transition to an active state in which substantially all of the components of the device are fully powered (e.g., to wake the device up).

In a further embodiment, the power management controller can control the device to transition between an intermediate power state and a substantially powered down state based on the expected time until the next wakeup event exceeding a threshold. In an embodiment, the substantially powered down state is the connected-standby state. For example, the power management controller can control the device to transition to a connected-standby state based on a determination that the next wakeup event is not expected for a certain period of time that exceeds a specified threshold. The determination can be based on, e.g., the status of timers or an interrupt predictor. After transitioning to the substantially powered down state, if a wakeup event is detected, the device can be transitioned to the active state.

In an embodiment, the values for the thresholds can be determined based on the wakeup time associated with that state. For example, in an embodiment in which the power management controller can transition the device to several different intermediate power states, the thresholds to transition between intermediate power states can increase as the wakeup time increases. For example, increasing the thresholds with the wakeup time associated with the state can prevent the negative impacts of transitioning to a low power state for a time that is shorter than or substantially similar to the wakeup time from that state. In an embodiment, the thresholds can be predetermined values programmed into the power management controller.

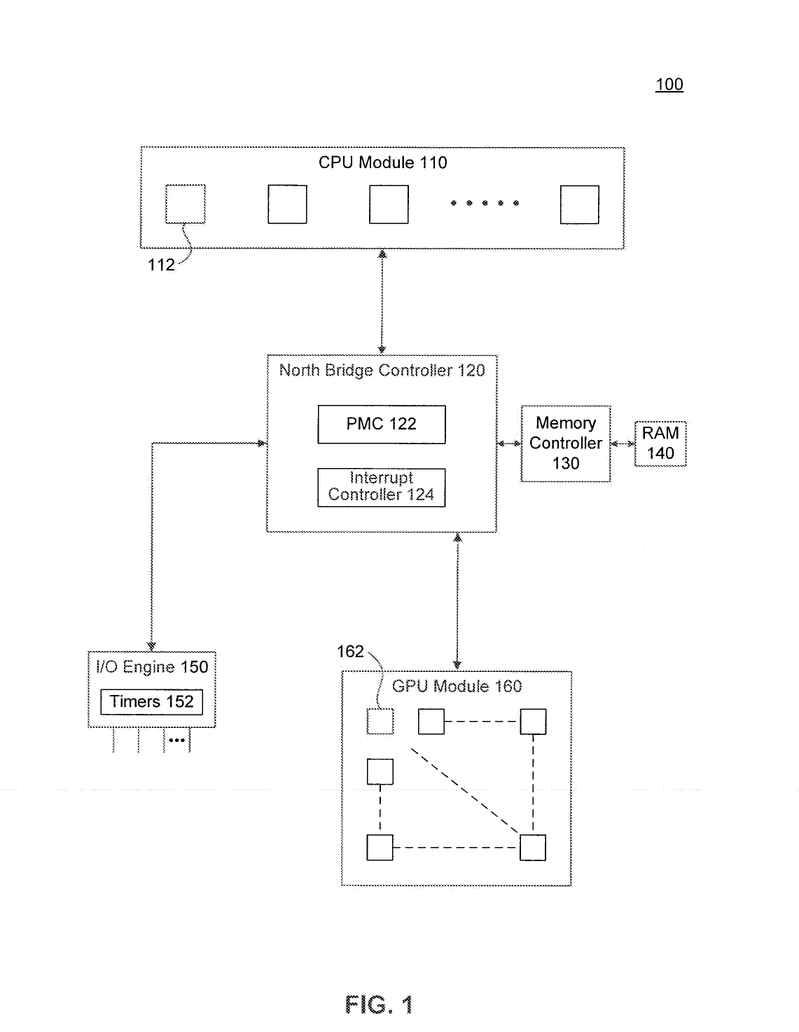

FIG. 1 shows a block diagram of a device 100, according to an embodiment. Device 100 includes a central processing unit (CPU) module 110, a North Bridge controller 120, a memory controller 130, a random access memory (RAM) 140, an input/output (I/O) engine 150, and an accelerated processing unit (APU) module 160. The components of device 100 can each be included in discrete circuit packages. In alternate embodiments, one or more of these components can be integrated in the same semiconductor package or the same semiconductor die.

CPU module 110 includes cores 112. In an embodiment, cores 112 can each be configured to execute instructions based on one or more operands. The operands can be stored, for example, locally, e.g., in registers of CPU module 110 (not shown in FIG. 1) or in other components of device 100 (e.g., random access memory 140). CPU module 110 can be configured such that different threads of an application are executed on different instances of cores 112.

North Bridge controller 120 can be configured to manage communications between the other elements of device 100. For example, North Bridge controller 120 can be configured to facilitate memory requests from CPU module 110 to memory controller 130. In an embodiment, North Bridge controller 120 is a shared resource between the CPU module 110 and GPU module 160. As shown in FIG. 1, North Bridge controller 120 includes a power management controller (PMC) 122 and an interrupt controller 124.

PMC 122 can be configured to manage the different power states of device 100. In an embodiment, PMC 122 is configured to transition device 100 between states in a manner that is invisible to the OS, thereby providing substantially shorter wakeup times. For example, PMC 122 may be configured to save state for device 100 without the aid of the OS. PMC 122 can be software, hardware, firmware component, or a combination thereof. For example, in an embodiment, PMC 122 can be implemented as a microcontroller including both hardware and firmware. In an alternate embodiment, PMC 122 can be implemented as low level software. The operation of PMC 122 will be described in greater detail below.

Interrupt controller 124 can be used to generate an interrupt for one or more components of device 100 based on a variety of events. For example, interrupt controller 124 can be configured to generate interrupts that act as wakeup events for device 100. In an embodiment, upon receiving communication from a user at input/output engine 150, e.g., a movement of a mouse or key strokes on a keyboard, interrupt controller 124 can generate an interrupt that will awaken device 100.

Memory controller 130 can be configured to control access to RAM 140. For example, the values used in the operation of other components of device 100 can be stored in RAM 140. When these values are needed, the specific component can interact with memory controller 130. Memory controller 130 can be configured to retrieve a requested value and/or update values already stored in RAM 140 based on requests from other devices in device 100.

I/O engine 150 can be used to manage the interaction between device 100 and other devices. For example, I/O engine 150 can be configured to manage communications to or from a user that interacts with device 100 using a communications device, e.g., a keyboard, a mouse, or LJSB device. As shown in FIG. 1, I/O engine 150 includes timers 152. Timers 152 can be configured to a fire at certain, predetermined intervals. For example, an OS of device 100 can configure one or more timers to fire at a predetermined set of intervals to trigger system diagnostic tests on device 100.

GPU module 160 includes clusters 162. Each one of clusters 162 can be used to execute one or more instructions. In an embodiment, GPU module 160 is configured to execute relatively large sets of parallel executions. For example, GPU module 160 can be configured as a single instruction multiple data device (SIMD). In a SIMD, a single instruction is executed on a subset or all of the processing elements with different data. In an embodiment, GPU module 160 can be coupled to a display device, e.g., a screen with a matrix of pixels (not shown in FIG. 1).

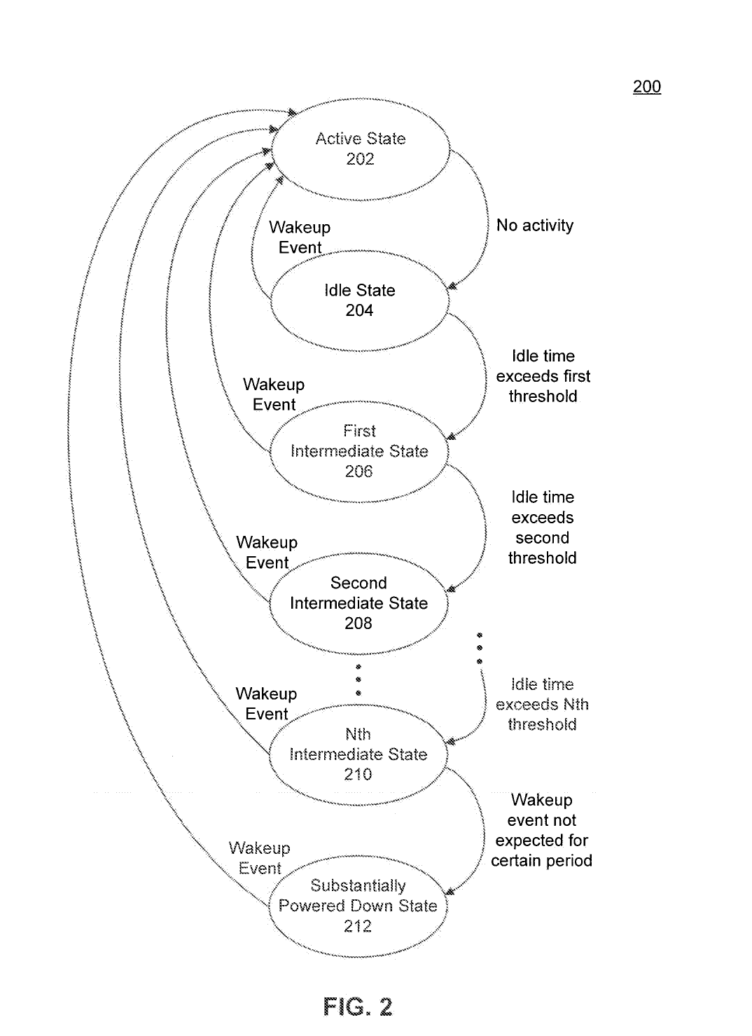

FIG. 2 shows a state diagram 200 illustrating different power states for device 100, according to an embodiment. In an active state 202, all or substantially all of the components of device 100 are fully powered and one or more of them is active. Activity on device 100 can take many different forms. For example, activity can include one or more of executing tasks in CPU module 110, executing tasks in GPU module 160, managing communications in North Bridge controller 120, servicing memory requests in memory controller 130, or managing communications in external devices with I/O engine 150.

If it is determined that there is no activity on the part of any of the components of device 100, e.g., none of the components are currently executing a task, device 100 can be transitioned to an idle state. As will be described in greater detail below, in the idle state, the power supplied to one or more components of device 100 is reduced. In an embodiment, the transition between active state 202 and idle state 204 is managed by the OS of device 100.

Transitioning to an intermediate state and from one intermediate state to another can be based on idle time thresholds. In the embodiment of FIG. 2 when device 100 is in idle state 204 and the idle time exceeds a first threshold, device 100 is transitioned to a first intermediate state 206. Moreover, as shown in FIG. 2, transitions between intermediate states 206, 208, and 210 are determined based on the idle time exceeding thresholds respective to each state.

In an embodiment, the threshold for transitioning to a specific intermediate state is determined based on the wakeup time from that state. For example, the wakeup time of first intermediate state 206 can be approximately 100 μs. Thus, the first threshold may be equal to or larger than 100 μs to prevent the performance deterioration that arises from rapid transitions between states. In an embodiment, as a device transitions from first intermediate state 206 to Nth intermediate state 210, the thresholds. In a further embodiment, transitions to each intermediate state 206 may result in a specific component being powered down. For example, transitioning to first intermediate state 206 can result in CPU module 110 of device 100 being powered down and transitioning to second intermediate state 208 can result in GPU module 160 being powered down.

As shown in FIG. 2, once the device has reached the last intermediate state, e.g., Nth intermediate state 210 as shown in FIG. 2, device 100 can transition to substantially powered down state 212. In determining whether to transition to substantially powered down state 212, PMC 122 can determine whether a wakeup event is expected for a predetermined period of time. For example, an interrupt predictor can be used to predict when the next interrupt is expected to be generated. In another embodiment, the PMC 122 can determine if any of the timers 152 are set to fire in during the predetermined. The period of time used in determining whether to transition to substantially powered down state 212 can be based on the wakeup time associated with substantially powered down state 212. For example, the wakeup time can be on the order of 100 ms. Thus, the threshold can be equal to or larger than this value.

Moreover, determining whether to transition to substantially powered down state 212 can also include determining whether device 100 has security state information that would have to be retained. As noted above, device 100 may include security state information that cannot be retained in a substantially powered state, e.g., the connected-standby state. The security state information can include, e.g., signatures that are used to check the validity of segments of code. To prevent this security information from being compromised, it may be required that this information be retained in a specific module, e.g., as opposed to RAM 140. Thus, this information may be retained in the substantially powered down state in which modules of device 100 may be completely powered down. Thus, in determining whether to transition to the substantially powered down state, PMC 122 can also consider whether device 100 has security state information.

As shown in FIG. 2, whenever a wakeup event, e.g., and interrupt or other activity is detected, device 100 can immediately transition to active state 202. In an embodiment, certain types of state information, e.g., security information, must be retained in device 100. In such an embodiment, device 100 may not transition to substantially powered down state 212. Instead, the deepest low power state to which device 100 transition is the Nth intermediate state 210.

Substantially powered down state 212 can be the lowest power state available for device 100. For example, substantially powered down state 212 can be implemented as the connected-standby state. In another embodiment, the substantially powered down state can be implemented as a complete power down of device 100 (except for PMC 122).

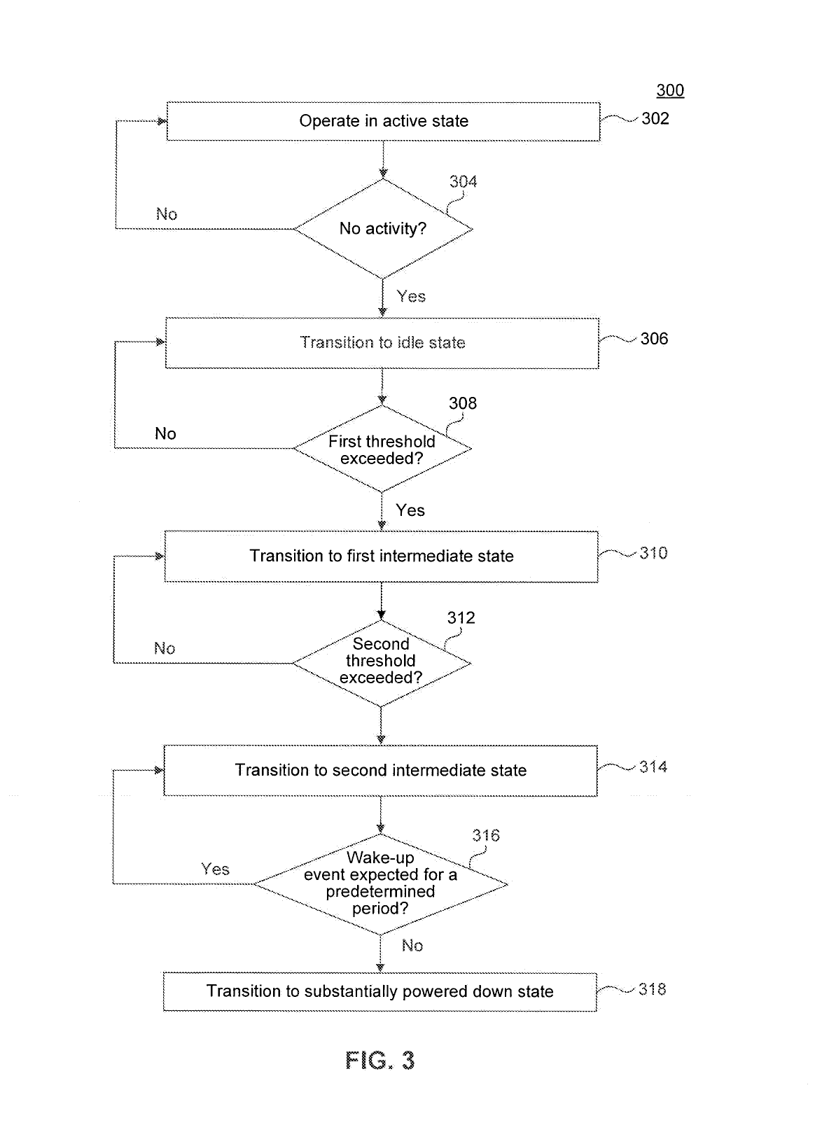

FIG. 3 shows a method of managing a power state of a device, according to an embodiment. Not all steps of method 300 may be required, nor do all these steps shown in FIG. 3 necessarily have to occur in the order shown. In an embodiment, method 300 is an implementation of state diagram 200 with two intermediate states (i.e., N=2). Flowchart 300 is described with reference to the embodiment of device 100, but is not limited to that embodiment.

In step 302, the device operates in an active state. For example, in the embodiment of FIG. 1, device 100 can be in the active state when one or more of CPU module 110, North Bridge controller 120, memory controller 130, RAM 140, I/O engine 150, and GPU module 160 are active, e.g., executing a task. In an embodiment, in the active state, all of the components of device 100 can be fully powered.

In step 304, it is determined whether no activity is present in the device. For example, in FIG. 1, the OS of device 100 can determine whether activity is present in any of the components of device 100. If so, flowchart 300 returns to step 302 and device 100 continues to operate in the active state. If, however, there is no activity present in device 100, flowchart 300 proceeds to step 306.

In step 306, the device is transitioned to an idle state. For example, in FIG. 1, device 100 can be transitioned by the OS of device 100. In an embodiment, in the idle state, CPU cores 112 are “power gated,” the voltage provided to North Bridge controller 120 is reduced, and the power provided to GPU module 160 is reduced. “Power gating” is a technique in which power is reduced or completely shut off to specific portions of a device through the use of, e.g., metal oxide semiconductor (MOS) transistors. For example, the power to specific portions of CPU cores 112 can be substantially reduced or shut off.

The voltage provided to North Bridge controller 120 in the idle state can be the minimum of voltage required to save state in North Bridge controller 120 and for it to continue its operation. As shown in FIG. 1, PMC 122 is included in North Bridge controller 120. In an embodiment, transitioning to different power states may not affect the power provided to PMC 122. For example, in an embodiment, the operation of PMC 122 may be deemed important to the different power states of device 100, and thus it may remain fully powered in all states. Moreover, PMC 122 may also save state of device 100, and therefore may need to remain fully powered.

In step 308, it is determined whether a first threshold for idle time has been exceeded. As noted above, the idle time can be measured as the time since the last activity on a device was completed. For example, in FIG. 1, PMC 122 can determine whether an idly time for device 100 has exceeded a first threshold. In an embodiment, the first threshold can be determined based on the wakeup time for the first intermediate state. For example, the wakeup time for the first intermediate state can be on the order of 100 μs. Thus, the first threshold can be a predetermined time can be approximately equal to or greater than 100 μs. In an embodiment, the first idle time threshold can be a predetermined value that is stored in PMC 122. As noted above, determining the threshold time based on the wakeup time from the respective state prevents the performance deterioration that comes with rapid transitioning between states. If it is determined that the first threshold has not yet been exceeded, the device remains in the idle state. Otherwise, flowchart 300 proceeds to step 310.

In step 310, the device is transitioned to the first intermediate state. For example, in embodiment of FIG. 1, PMC 122 can transition device 100 to a first intermediate state. For example, PMC 122 can power down CPU cores 112 and power gate APU cores 162. In a further embodiment, North Bridge controller 120 can remain supplied with a low voltage (e.g., the minimum voltage needed to support operation and save state).

In step 312, it is determined whether a second idle time threshold has been exceeded. For example, in FIG. 1, PMC 122 can determine whether the idle time has exceeded a second threshold associated with the second intermediate state. For example, the wakeup time of the second intermediate state can be on the order of 10 ms. Thus, the second threshold can be approximately equal to or greater than 10 ms. In an embodiment, the second threshold is a predetermined time period that is stored in PMC 122. if the second threshold has not yet been exceeded, flowchart 300 returns to step 308. If, however, the second idle time threshold has been exceeded, the device flowchart 300 proceeds to step 314.

In step 314, the device is transitioned to a second intermediate state. For example, in FIG. 1, PMC 122 can transition device 100 to a second intermediate state. For example, PMC 122 can transition device 100 from the first intermediate state to the second intermediate state by powering down GPU module 160. Thus, in transitioning to the second intermediate state, PMC 122 can transition GPU module 160 from a state in which cores 162 of GPU module 160 are power gated to a state in which GPU module 160 is powered down. Ina further embodiment, North Bridge controller 120 remains supplied with a low voltage (e.g., the minimum voltage needed to support operation and save state).

In step 316, it is determined whether to transition to the substantially powered down state. For example, in FIG. 1, PMC 122 can determine whether a wakeup event is expected for a predetermined time.

For example, PMC 122 can interact with I/O engine 150 to determine whether any of timers 152 are set to fire within the predetermined time. Timers 152 can be software or firmware controlled elements that can be used to trigger different events that cause activity on device 100. For example, one or more of timers 152 can be used to trigger a diagnostic scan of device 100. Those skilled in the art will appreciate that timers 152 can be used to trigger other events. PMC 122 can query I/O engine 150 to determine how much time is remaining on each of timers 152. Additionally or alternatively, PMC 122 can also determine how much time is remaining individual ones of timers 152 by storing the time when those timers fired last, using those times to determine how long it has been since the last firing for each timer, and comparing the times since the last firing to a stored value corresponding to the period of the respective timer. In an embodiment, PMC 122 can use the minimum time remaining for timers 152 as a prediction of the time until the next wakeup event.

In another embodiment, PMC 122 can use an interrupt predictor to predict whether an interrupt will be generated by interrupt controller 124 in the predetermined time. For example, PMC 122 can implement one or more algorithms that use, for example, the interrupt history of device 100 to predict when the next interrupt will be generated. The interrupt prediction algorithm can also factor in the length of the current idle time in determining whether an interrupt is expected for the predetermined time. Moreover, the interrupt prediction may also be a function of a signal received from a device coupled to I/O engine 150, which indicates that an interrupt in not expected for the predetermined time. If a wakeup event is expected within the predetermined time, flowchart 300 returns to step 314. Otherwise, flowchart 300 advances to step 318.

Moreover, determining whether to transition to substantially powered down state 212 can also include determining whether device 100 has security state information that would have to be retained. As noted above, device 100 may include security state information that cannot be retained in a substantially powered state, e.g., the connected-standby state. Thus, in determining whether to transition to the substantially powered down state, PMC 122 can also consider whether device 100 has security state information. If so, PMC 122 may determine that the second intermediate state is the deepest low power state to which device 100 can transition.

In step 318, the device is transitioned to a substantially powered down state. For example, in FIG. 1, PMC 122 can transition device 100 to a substantially powered down state. In the substantially powered down state, substantially all components of device 100 can be powered down. For example, CPU module 110, memory controller 130, I/O engine 150, GPU module 160, and the components of North Bridge controller 120 other than PMC 122. can be substantially powered down. In an embodiment, RAM 140 can remain powered so that its contents are not lost. The substantially powered down state can be implemented as the connected standby state.

As noted above in the description relating to FIG. 2, whenever a wakeup event is received, the device can be transitioned to an active state. Thus, in the embodiment of FIG. 3, if a wakeup event is received, device 100 may immediately be transitioned to the active state.

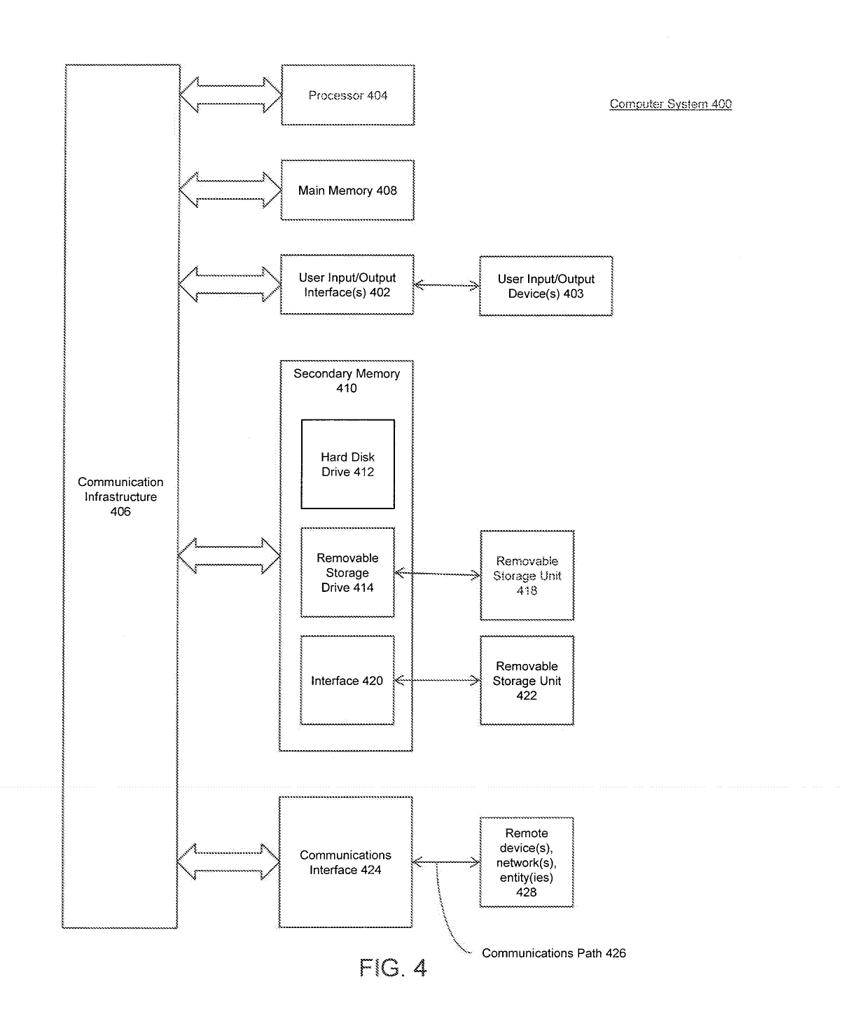

Various embodiments (e.g., PMC 122) can be implemented, for example, using one or more well-known computer systems, such as computer system 400 shown in FIG. 4. Computer system 400 can be any well-known computer capable of performing the functions described herein.

Computer system 400 includes one or more processors (also called central processing units, or CPUs), such as a processor 404. Processor 404 is connected to a communication infrastructure or bus 406.

Computer system 400 also includes user input/output device(s) 403, such as monitors, keyboards, pointing devices, etc., which communicate with communication infrastructure 406 through user input/output interface(s) 402.

Computer system 400 also includes a main or primary memory 408, such as random access memory (RAM). Main memory 408 may include one or more levels of cache. Main memory 408 has stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to an exemplary embodiment, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 42$ over communications path 426, which may be wired and/or wireless, and which may include any combination of LANs, WANs, the Internet, etc. Control logic and/or data may be transmitted to and from computer system 400 via communication path 426.

In an embodiment, a tangible apparatus or article of manufacture comprising a tangible computer useable or readable medium having control logic (software) stored thereon is also referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), causes such data processing devices to operate as described herein.

For example, in addition to implementations using hardware (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer readable code, program code, instructions and/or data disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can he accomplished through. the use of general programming languages (e.g., C, C++), GDII databases, hardware description languages (HDL) including Verilog HDL, VHDL, SystemC, SystemC Register Transfer Level (RTL), and so on, or other available programs, databases, and/or circuit (i.e., schematic) capture tools. Such software can be disposed in any known computer usable medium including semiconductor, magnetic disk, optical disk (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets.

It is understood that the apparatus and method embodiments described herein may be included in a semiconductor intellectual property core, such as a microprocessor core (e.g., embodied in HDL) and transformed to hardware in the production of integrated circuits. Additionally, the apparatus and methods described herein may be embodied as combination of hardware and software. Thus, the present disclosure should net be limited by any of the above-described exemplary embodiments, but should be defined only in accordance with the following claims and their equivalence.

Based on the teachings contained in this disclosure, it will be apparent to persons skilled in the relevant art(s) how to make and use the disclosed embodiments using data processing devices, computer systems and/or computer architectures other than that shown in FIG. 4. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so filly reveal the general nature of the disclosed and contemplated embodiments that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A method, comprising:
responsive to a determination that an idle time has exceeded a threshold, transitioning device to an intermediate power state in which a predetermined processing module of the device is powered down, wherein the idle time is a time since a last wakeup event; and
determining whether to transition the device from the intermediate power state to a substantially powered down state.

2. The method of claim 1, wherein the intermediate power state is a first intermediate power state and wherein the threshold is a first threshold, the method further comprising:
responsive to a determination that the idle time has exceeded a second threshold, transitioning the device to a second intermediate power state in which a second predetermined processing module of the device is powered down.

3. The method of claim 2, wherein transitioning the device to the first intermediate power state comprises transitioning the device from the second intermediate power state to the first intermediate power state.

4. The method of claim 2, wherein transitioning the device to the second intermediate power state comprises transitioning the device from an idle state to the first intermediate power state.

5. The method of claim 2, wherein the second predetermined processing module comprises a central processing unit (CPU) module.

6. The method of claim 1, wherein predetermined processing module comprises an accelerated processing device.

7. The method of claim 1, wherein the determining comprises:
determining that the next wakeup event is not expected for the predetermined time.

8. The method of claim 7, wherein the determining further comprises:
determining that a system timer of the device will not expire in the predetermined time.

9. The method of claim 7, wherein the determining further comprises:
predicting when a next interrupt will be generated.

10. The method of claim 1, wherein the determining further comprises:
determining whether security state information for device must be retained.

11. A non-transitory computer-readable device having instructions stored thereon that, when executed by at least one computing device, causes the at least one computing device to perform operations comprising:
responsive to a determination that an idle time has exceeded a threshold, transitioning a device to an intermediate power state in which a predetermined processing module of the device is powered down, wherein the idle time is a time since a last wakeup event; and
determining whether to transition the device from the intermediate power state to a substantially powered down state.

12. The computer-readable device of claim 11, wherein the intermediate power state is a first intermediate power state and wherein the threshold is a first threshold, the operations further comprising:
responsive to a determination that the idle time has exceeded a second threshold, transitioning the device to a second intermediate power state in which a second predetermined processing module of the device is powered down.

13. The computer-readable device of claim 12, wherein transitioning the device to the first intermediate power state comprises transitioning the device from the second intermediate power state to the first intermediate power state.

14. The computer-readable device of claim 12, wherein transitioning the device to the second intermediate power state comprises transitioning the device from an idle state to the first intermediate power state.

15. The computer-readable device of claim 12, wherein the second predetermined processing module comprises a central processing unit (CPU) module.

16. The computer-readable device of claim 11, wherein predetermined processing module comprises an accelerated processing device.

17. The computer-readable device of claim 11, wherein the determining comprises:
determining that the next wakeup event is not expected for the predetermined time.

18. The computer-readable device of claim 17, wherein the determining further comprises:
determining that a system timer of the device will not expire in the predetermined time.

19. The computer-readable device of claim 17, wherein the determining further comprises:
predicting when a next interrupt will be generated.

20. The computer-readable device of claim 11, wherein in the intermediate power state, a minimum supply voltage is provided to a North Bridge controller of the device and wherein, in the substantially powered down state, the North Bridge controller is powered down.
